(19) United States
(12) Patent Application Publication
(10) Pub. No.: US 2017/0103190 A1
(43) Pub. Date: Apr. 13, 2017

(54) SYSTEM AND METHOD FOR EVALUATING RISKS OF CLINICAL TRIAL CONDUCTING SITES

(71) Applicant: Algorithm Inc, Houston, TX (US)

(72) Inventors: Abby Abraham, Bangalore (IN); Allabux Jaffer, Bangalore (IN); Nithiyanandhan Ananthakrishnan, Bangalore (IN); Hazel Sidona, Bangalore (IN)

(21) Appl. No.: 15/288,075

(22) Filed: Oct. 7, 2016

Related U.S. Application Data
(60) Provisional application No. 62/239,495, filed on Oct. 9, 2015.

(51) Int. Cl. G06F 19/00

(52) U.S. Cl. CPC G06F 19/363; G06F 19/3431

(57) ABSTRACT

A computer implemented method for evaluating risks of clinical trial conducting sites is provided. The method includes steps of (i) obtaining a first data that corresponds to a first duration from the clinical trial conducting sites; (ii) performing a regression analysis on the first data to obtain a number of monitoring visit findings at a site in accordance with an equation (Y)=B1X1+B2X2+ . . . BnXn+ error; (iii) obtaining regression coefficients by applying the equation on the first data; (iv) obtaining a second data that corresponds to a second duration from the clinical trial conducting sites; (v) applying the regression coefficients on the second data to predict potential risks associated with the clinical trial conducting sites; (vi) computing an overall risks associated with the clinical trial conducting sites; and (vii) classifying a risk level associated with the site based on the overall risk associated with the clinical trial conducting site.

### CROSS-REFERENCE TO RELATED APPLICATIONS

This application claims priority to U.S. patent application No. 62/239,495 filed on Oct. 10, 2015, the complete disclosure of which, in its entirely, is herein incorporated by reference.

### BACKGROUND

Technical Field

The embodiments herein generally relate to a system and method for evaluating risks of clinical trial conducting sites, and more particularly, to a system and method for evaluating risks of clinical trial conducting sites using regression analysis.

Description of the Related Art

Generally clinical trials are conducted on subjects to analyse performance data of drugs, diagnostics, devices, therapy protocols, and other health or disease management related aspects. Typically, centers, clinics and hospitals at which clinical trials are conducted are known as clinical trial conducting sites. Issues in data quality and site compliance with the study protocol and regulatory requirements can increase time required to complete a study. Unforeseen developments in the field can increase both data and procedural errors. Correction of both data errors and procedural errors consumes sponsor resources. The ability to correct errors is dependent on access to timely information about what is happening in the field and the ability to respond dynamically to unforeseen developments. Therefore, there is a need for a system and method for forecasting the performance of clinical trial conducting sites and take proactive actions to improve the conduct of clinical trials. The existing approaches attempt to evaluate risks associated with clinical trial conducting sites by analysing past and present performance of the sites. However, such approaches have failed in forecasting performances of the clinical trial conducting sites. Accordingly, there remains a need for a system and method that forecasts performance of clinical trial conducting sites and facilitates proactive actions to improve the conduct of the clinical trials.

### SUMMARY

In view of the foregoing, an embodiment herein provides a system for evaluating risks of clinical trial conducting sites is provided. The system includes a memory and a processor. The memory stores (i) a set of modules, and (ii) a database. The database stores a risk level associated with each of the clinical trial conducting sites. The processor executes the set of modules. The set of modules includes a first duration data obtaining module, a regression analysis module, a regression coefficients computing module, a second duration data obtaining module, a regression coefficients applying module, an overall site risks computing module and a site risk classifying module. The first duration data obtaining module, implemented by the processor, obtains a first data corresponding to a first duration. The first data includes parameters associated with (i) protocol risks, (ii) site performance risks, and (iii) site process risks of the clinical trial conducting sites. The regression analysis module, implemented by the processor, performs a regression analysis on the first data to obtain a number of monitoring visit findings at a clinical trial conducting site in accordance with an equation (Y)=B1X1+B2X2+ . . . BnXn+ error, where X1, X2, . . . Xn are parameters and Y is the number of monitoring visit findings at the clinical trial conducting site. The regression coefficients computing module, implemented by the processor, applies the equation on the first data to obtain regression coefficients. The second duration data obtaining module, implemented by the processor, obtains a second data corresponding to a second duration. The second data includes parameters associated with (i) the protocol risks, (ii) the site performance risks, and (iii) the site process risks of the clinical trial conducting sites. The regression coefficients applying module, implemented by the processor, applies the regression coefficients on the second data to predict potential risks associated with the clinical trial conducting sites. The overall site risks computing module, implemented by the processor, computes an overall risks associated with the clinical trial conducting sites. The site risk classifying module, implemented by the processor, classifies a risk level as high, medium, or low that associated with the clinical trial conducting site based on the overall risk associated with the clinical trial conducting site.

In one embodiment, the overall site risks computing module includes a protocol compliance risk score computing module, a site performance risk score computing module and a site process risk score computing module. The protocol compliance risk score computing module, implemented by the processor, computes a protocol compliance score for each clinical trial conducting sites by applying the regression coefficients on the second data. The site performance risk score computing module, implemented by the processor, computes a site performance score for the each clinical trial conducting sites by applying the regression coefficients on the second data. The site process risk score computing module, implemented by the processor, computes a site process compliance score for the each clinical trial conducting sites by applying the regression coefficients on the second data.

In another embodiment, the system is implemented using at least one (i) statistical models under generalized linear model (GLM), or (ii) a statistical models selected from (a) Linear Regression, (b) Logistic Regression, (c) Polynomial Regression, (d) Stepwise Regression, (e) Ridge Regression, (f) Lasso Regression, and (g) ElasticNet Regression to evaluate the overall risks associated with the clinical trial conducting sites. In yet another embodiment, the overall risks associated with the clinical trial conducting sites is computed based on (i) the corresponding protocol compliance risk scores, (ii) the corresponding site performance scores, and (ii) the corresponding site process compliance scores. In yet another embodiment, the first duration associated with the first data is calculated from a start of clinical trials until most recent interventions with the clinical trial conducting sites. In yet another embodiment, the second duration associated with the first data is calculated from recent interventions of the clinical trial conducting sites, in yet another embodiment, the second duration is calculated from (i) operational, medical, and study management, (ii) remote monitoring visit, (iii) telephonic follow-up, (iv) on-site visits, or (v) tele-presence till a current date. In yet another embodiment, the regression analysis module calculates a number of monitoring issues per the clinical trial conducting site by a mathematical form of a regression model

Y=B₁X₁+B₂X₂+ . . . BₙXₙ [PR]+B₁X₁+B₂X₂+ . . . BₙXₙ [Sp]+B₁X₁+B₂X₂+ . . . BₙXₙ [Spe], where PR is related to a protocol risk, Sp is related to a site process, and Spe is related to a site performance. X1 X2 . . . Xn are independent variables.

In yet another embodiment, the at least one parameter is selected by a clinical trial administrator to monitor the clinical trial conducting site. In yet another embodiment, the system allows to add one or more new risk categories and associated parameters to compute the overall risks associated with the clinical trial conducting sites.

In another aspect, a computer implemented method for evaluating risks of clinical trial conducting sites is provided. The method includes the following steps: (i) obtaining a first data that corresponds to a first duration from the clinical trial conducting sites; (ii) performing a regression analysis on the first data to obtain a number of monitoring visit findings at a clinical trial conducting site in accordance with an equation

(Y)=B1X1+B2X2+ . . . BnXn+ error,

where X1, X2, . . . Xn are parameters and Y is the number of monitoring visit findings at the clinical trial conducting site; (iii) obtaining regression coefficients by applying the equation on the first data; (iv) obtaining a second data that corresponds to a second duration from the clinical trial conducting sites; (v) applying the regression coefficients on the second data to predict potential risks associated with the clinical trial conducting sites; (vi) computing an overall risks associated with the clinical trial conducting sites; and (vii) classifying a risk level associated with the clinical trial conducting site based on the overall risk associated with the clinical trial conducting site.

In one embodiment, the first data includes parameters associated with (i) protocol risks, (ii) site performance risks, and (iii) site process risks of the clinical trial conducting sites. In another embodiment, the second data includes parameters associated with (i) the protocol risks, (ii) the site performance risks, and (iii) the site process risks of the clinical trial conducting sites. In yet another embodiment, the method further includes the step of recommending the clinical trial conducting site visit when the risk level associated with the clinical trial conducting site is higher than a predefined threshold value. In yet another embodiment, the method further includes step to compute the overall risks associated with the clinical trial conducting sites using the overall site risks computing module that performing steps of: (i) computing a protocol compliance score for each clinical trial conducting sites by applying the regression coefficients on the second data; (ii) computing a site performance score for the each clinical trial conducting sites by applying the regression coefficients on the second data; and (iii) computing a site process compliance score for the each clinical trial conducting sites by applying the regression coefficients on the second data.

In yet another embodiment, the overall risks associated with the clinical trial conducting sites is computed based on (i) the corresponding protocol compliance risk scores, (ii) the corresponding site performance scores, and (ii) the corresponding site process compliance scores. In yet another embodiment, the first duration associated with the first data is calculated from a start of clinical trials until most recent interventions with the clinical trial conducting sites. In yet another embodiment, the second duration associated with the first data is calculated from recent interventions of the clinical trial conducting sites, in yet another embodiment, the second duration is calculated from (i) operational, medical, and study management, (ii) remote monitoring visit, (iii) telephonic follow-up, (iv) on-site visits, or (v) tele-presence till a current date. In yet another embodiment, the method further includes step of calculating a number of monitoring issues per the clinical trial conducting site by a mathematical form of a regression model

Y=B₁X₁+B₂X₂+ . . . BₙXₙ[PR]+B₁X₁+B₂X₂+ . . . BₙXₙ[Sp]+B₁X₁+B₂X₂+ . . . BₙXₙ[Spe],

where PR is related to a protocol risk, Sp is related to a site process, and Spe is related to a site performance. X1 X2 . . . Xn are independent variables.

In yet another aspect, an one or more non-transitory computer readable storage mediums storing one or more sequences of instructions, which when executed by one or more processors, causes evaluating risks of clinical trial conducting sites, by performing the steps of: (i) obtaining a first data that corresponds to a first duration from the clinical trial conducting sites; (ii) performing a regression analysis on the first data to obtain a number of monitoring visit findings at a clinical trial conducting site in accordance with an equation

(Y)=B1X1+B2X2+ . . . BnXn+ error,

where X1, X2, . . . Xn are parameters and Y is the number of monitoring visit findings at the clinical trial conducting site; (iii) obtaining regression coefficients by applying the equation on the first data; (iv) obtaining a second data that corresponds to a second duration from the clinical trial conducting sites; (v) applying the regression coefficients on the second data to predict potential risks associated with the clinical trial conducting sites; (vi) computing a protocol compliance score for each clinical trial conducting sites by applying the regression coefficients on the second data; (vii) computing a site performance score for the each clinical trial conducting sites by applying the regression coefficients on the second data; (viii) computing a site process compliance score for the each clinical trial conducting sites by applying the regression coefficients on the second data; and (ix) classifying a risk level associated with the clinical trial conducting site based on the overall risk associated with the clinical trial conducting site.

In one embodiment, the first data includes parameters associated with (i) protocol risks, (ii) site performance risks, and (iii) site process risks of the clinical trial conducting sites. In another embodiment, the second data includes parameters associated with (i) the protocol risks, (ii) the site performance risks, and (iii) the site process risks of the clinical trial conducting sites. In yet another embodiment, overall risks associated with the clinical trial conducting sites computed based on (i) the corresponding protocol compliance risk scores, (ii) the corresponding site performance scores, and (ii) the corresponding site process compliance scores.

In yet another embodiment, the method further includes step of recommending the clinical trial conducting site visit when the risk level associated with the clinical trial conducting site is higher than a predefined threshold value. In yet another embodiment, the method further includes step of calculating a number of monitoring issues per the clinical trial conducting site by a mathematical form of a regression model

Y=B₁X₁+B₂X₂+ . . . BₙXₙ[PR]+B₁X₁+B₂X₂+ . . . BₙXₙ[Sp]+B₁X₁+B₂X₂+ . . . BₙXₙ[Spe],

where PR is related to a protocol risk, Sp is related to a site process, and Spe is related to a site performance. X1 X2 . . . Xn are independent variables.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrating a computing device that includes a risk analyser for evaluating risks associated with a plurality of sites according to an embodiment herein;

FIG. 2 is an exploded view of the risk analyser of the computing device of FIG. 1 according to an embodiment herein;

FIG. 3 is a user interface view illustrating a risk category field, a parameter field, and an enabling or disabling field according to an embodiment herein;

FIG. 4 is a table view illustrating a first data that is obtained from clinical trial conducting sites, and is specific to a first duration according to an embodiment herein;

FIG. 5 is an exemplary view illustrating performing a regression analysis on the first data of FIG. 4 to obtain regression coefficients for parameters associated with different risk categories including but not limited to protocol risks, the site performance risks, and the site process risks according to an embodiment herein;

FIG. 6 is a table view illustrating a second data that is obtained from clinical trial conducting sites, and is specific to a second duration according to an embodiment herein;

FIG. 7 is a table view illustrating a risk level associated with sites according to an embodiment herein;

FIG. 8 is a flow diagram illustrating a method for evaluating risks associated with a plurality of sites according to an embodiment herein; and

FIG. 9 is a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

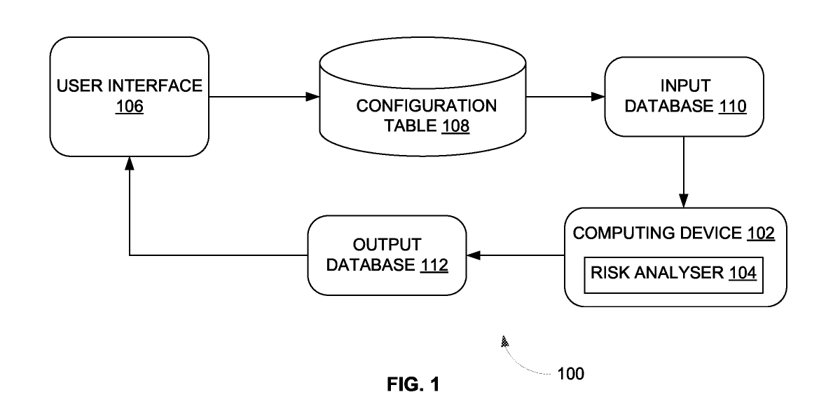

As mentioned, there remains a need for a system and method that enables foreseeing performances of clinical trial conducting sites and taking proactive actions to improve the conduct of the clinical trials. Referring now to the drawings and more particularly to FIGS. 1 through 9, where similar reference characters denote corresponding features consistently throughout the figures, preferred embodiments are shown.

FIG. 1 is a system view 100 illustrating a computing device 102 that includes a risk analyser 104 for evaluating risks associated with a plurality of sites according to an embodiment herein. In one embodiment, the plurality of sites is clinical trial conducting sites. Examples of categories of risks to be evaluated for clinical trial conducting sites include, but not limited to, protocol risks, site performance risks, and/or site process risks. Each of the protocol risks, site performance risks, and/or site process risks includes various parameters. The risk analyser 104 obtains values of parameters associated with the protocol risks, the site performance risks, and/or the site process risks, statistically analyses, and evaluates risks associated with the clinical trial conducting sites.

Examples of parameters associated with the protocol risks, the site performance risks, and/or the site process risks include, but not limited to, patients with protocol deviations, patients with adverse events, patients with early termination, patients failed screening, patients with serious adverse effects, patients with medical history, patients with concomitant medication, number of sites assigned to contract research associates, total monitoring issues, missing informed consent count, and/or missing drug accountability count.

The system view 100 further includes a user interface 106, a configuration table 108, an input database 110, and an output database 112. Each clinical trial has a clinical trial administrator who defines risks parameters to be monitored while conducting clinical trials. The configuration table 108 stores user inputs including risks parameters to be monitored during a clinical study and corresponding threshold values for the plurality of sites. The input database 110 inputs the user inputs to the risk analyser 104 for evaluating risks of the sites. In one embodiment, the computing device 102 is a laptop, a desktop, a tablet, a mini, a smartphone, etc.

The risk analyser 104 obtains a first data associated with clinical trial conducting sites including values of parameters associated with the protocol risks, the site performance risks, and/or the site process risks. The first data is specific to a first duration (i.e., from a start of a clinical trial until a most recent intervention with a site). The risk analyser 104 applies a regression model on the first data, and computes regression coefficients for each of the parameters. The risk analyser 104 applies the regression coefficients on a second data associated with the clinical trial conducting sites, and forecasts risks of the clinical trial conducting sites. The second data is specific to a second duration (i.e., from the most recent intervention with sites including, but not limited to, from operational, medical, and study management, remote monitoring visit, telephonic follow-up, on-site visits, and tele-presence to a current date). The output database 112 stores a risk level (e.g., high, medium, or low) associated with each of the clinical trial conducting sites. In one embodiment, the risk analyser 104 alerts a user for an immediate action when a risk level associated with a clinical trial conducting site is high.

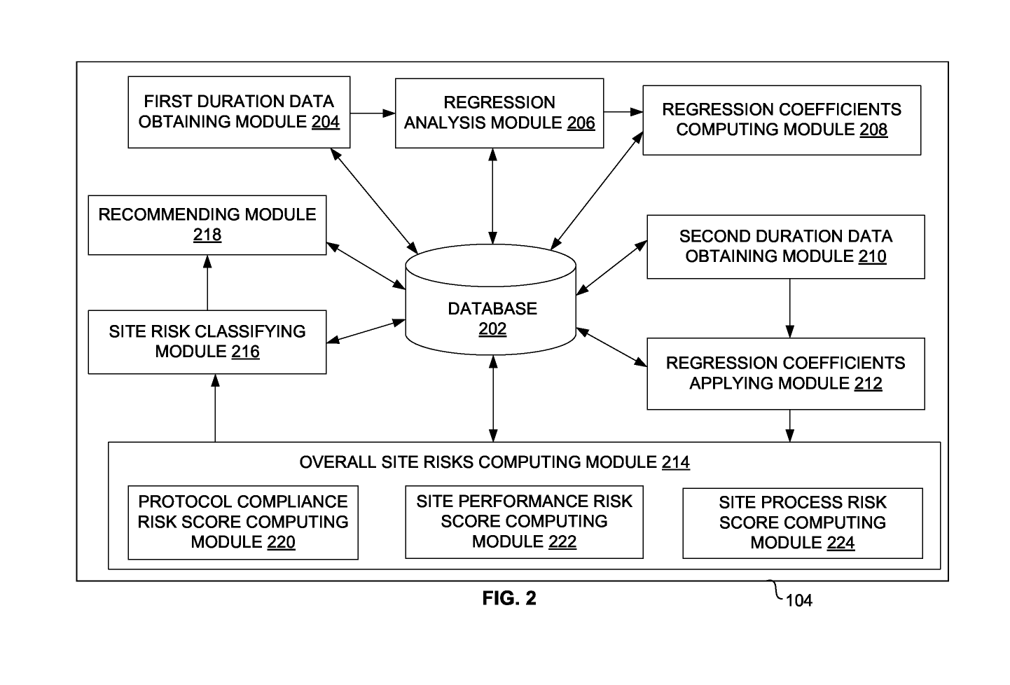

FIG. 2 is an exploded view of the risk analyser 104 of the computing device 102 of FIG. 1 according to an embodiment herein. The risk analyser 104 includes a database 202, a first duration data obtaining module 204, a regression analysis module 206, a regression coefficients computing module 208, a second duration data obtaining module 210, a regression coefficients applying module 212, an overall score computing module/overall site risks computing module 214, a sites risk classifying module 216, and a recommending module 218. The first duration data obtaining module 204 obtains a first data including parameters associated with the protocol risks, the site performance risks, and/or the site process risks of clinical trial conducting sites, and corresponding values for a first duration. The first duration is calculated from a start of clinical trials until most recent interventions with the sites. The regression analysis module 206 performs an analysis on the first data in accordance with an equation

(Y)=B1X1+B2X2+ . . . BnXn+ error Eq. 1

where X1, X2, Xn are parameters or key risk indicators or predictor variables that are also classified into site performance parameters, site process parameters and protocol compliance parameters to support in risk identification and mitigation, and Y is a number of monitoring visit findings at a site. A mathematical form of a regression model is given below.

Y=B₁X₁+B₂X₂+ . . . BₙXₙ[PR]+B₁X₁+B₂X₂+ . . . [Sp]+B₁X₁+B₂X₂+ . . . BₙXₙ[Spe]

Where PR is related to a protocol risk, Sp is related to a site process, and Spe is related to a site performance. X1 X2 . . . Xn are independent variables for the respective categories, and Y is a number of monitoring issues per site.

The regression coefficients computing module 208 applies the above equation 1 on the first data to obtain regression coefficients. The second duration data obtaining module 210 obtains a second data including parameters associated with the protocol risks, the site performance risks, and/or the site process risks of the clinical trial conducting sites, and corresponding values for a second duration. The second duration is from the most recent interventions of clinical trial conducting sites including, but not limited to, from operational, medical, and study management, remote monitoring visit, telephonic follow-up, on-site visits, and tele-presence till a current date. The regression coefficients applying module 212 applies the regression coefficients on the second data to predict potential risks associated with the clinical trial conducting sites.

The overall site risks computing module 214 includes a protocol compliance risk score computing module 220, a site performance risk score computing module 222, and a site process risk score computing module 224. The protocol compliance risk score computing module 220 computes a protocol compliance score for each site by applying the regression coefficients on the second data. The site performance risk score computing module 222 computes a site performance score for each site by applying the regression coefficients on the second data. Similarly, the site process risk score computing module 224 computes a site process compliance score for each site by applying the regression coefficients on the second data. The overall site risks computing module 214 computes overall risks associated with sites based on corresponding protocol compliance scores, corresponding site performance scores, and corresponding site process compliance scores. The sites risk classifying module 216 classifies a risk level (e.g., high, medium, or low) associated with a site based on an overall risk associated with the site. The recommending module 218 recommends a site visit when a risk level associated with the site is higher than a predefined threshold value. The database 202 stores the risk level associated with each of the clinical trial conducting sites.

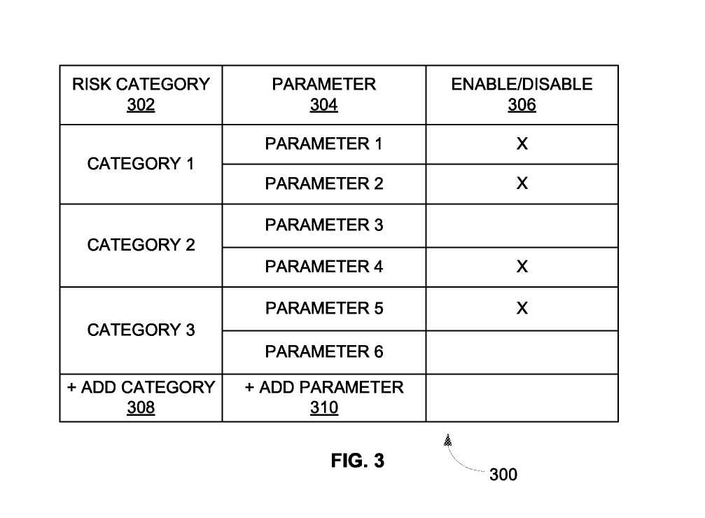

FIG. 3 is a user interface view 300 illustrating a risk category field 302, a parameter field 304 and an enabling or disabling field 306 according to an embodiment herein. The risk category field 302 displays a plurality of risks categories associated with sites (e.g., protocol risks, site performance risks, and/or site process risks). The parameter field 304 displays a plurality of parameters associated with the risk categories (e.g., protocol risks, site performance risks, and/or site process risks). A clinical trial administrator may select one or more parameters to be monitored for a site by enabling the one or more parameters using the enabling or disabling field 306. A clinical trial administrator adds one or more new risk categories and associated parameters using an add category field 308 and an add parameter field 310 respectively.

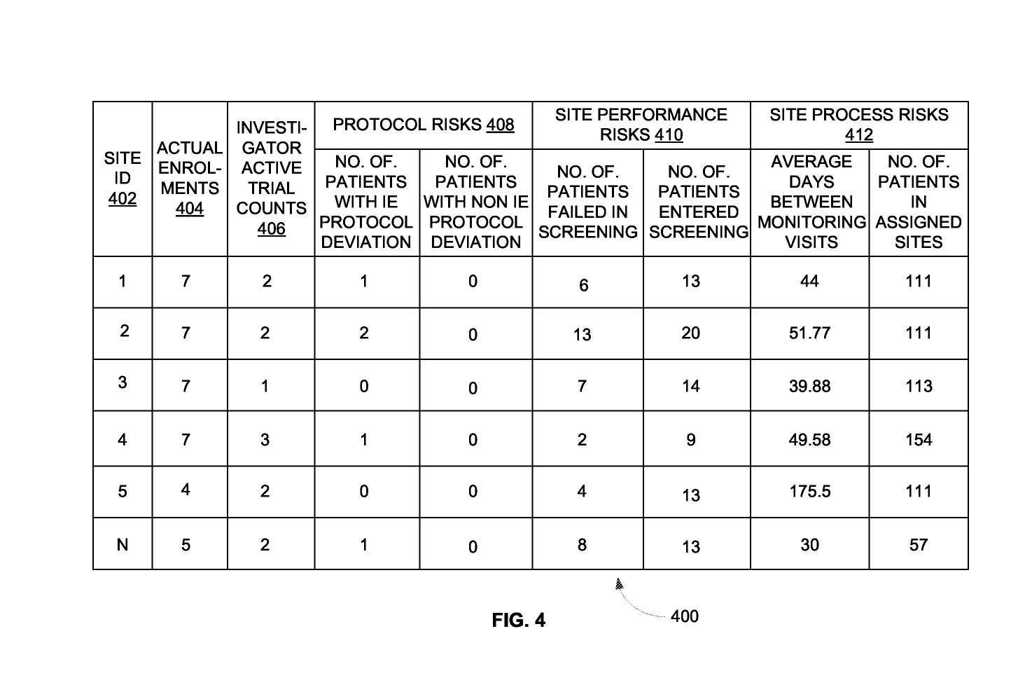

FIG. 4 is a table view illustrating a first data 400 that is obtained from clinical trial conducting sites, and is specific to a first duration according to an embodiment herein. The first data 400 includes site ID's 402 associated with a plurality of sites (i.e., sites 1 to N), actual enrolments 404, investigator active trial counts 406, parameters of protocol risks 408, parameters of site performance risks 410, and parameters of site process risks 412 for each site, and corresponding values. Example parameters of the protocol risks 408 include number of patients with IE protocol deviation and number of patients with non IE protocol deviation. Example parameters of the site performance risks 410 include number of patients failed in screening and number of patients entered screening. Example parameters of the site process risks 412 include average days between patient's monitoring visits and number of patients in assigned sites. A person having ordinary skill in the art will appreciate examples of parameters is not limited only to those listed in the FIG. 4.

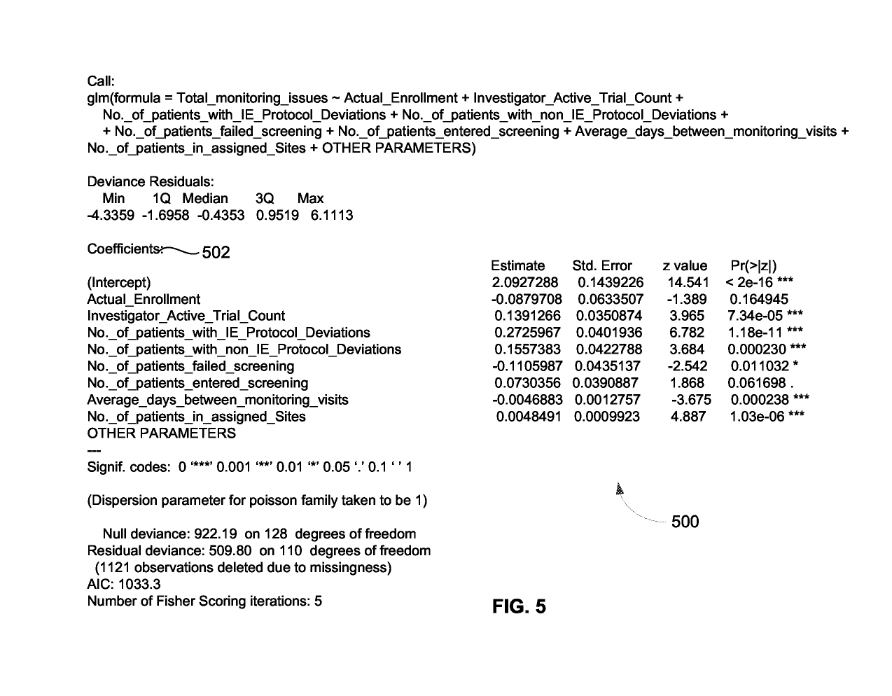

With reference to FIG. 4, FIG. 5 is an exemplary view 500 illustrating performing a regression analysis on the first data 400 of FIG. 4 to obtain regression coefficients 502 for parameters associated with different risk categories including, but not limited to, the protocol risks 408, the site performance risks 410, and the site process risks 412 according to an embodiment herein.

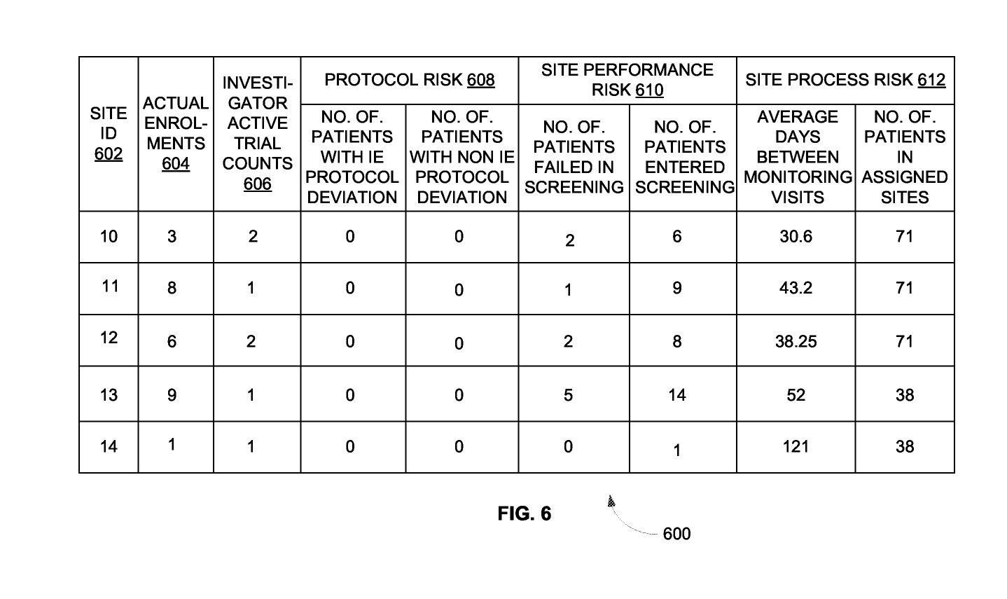

FIG. 6 is a table view illustrating a second data 600 that is obtained from clinical trial conducting sites, and is specific to a second duration according to an embodiment herein. The second data 600 includes site ID's 602 associated with a plurality of sites (i.e., sites 10 to 14), actual enrolments 604, investigator active trial counts 606, parameters of protocol risks 608, parameters of site performance risks 610, and parameters of site process risks 612 for each site, and corresponding values. Example parameters of the protocol risks 608 include number of patients with IE protocol deviation and number of patients with non IE protocol deviation. Example parameters of the site performance risks 610 include number of patients failed in screening and number of patients entered screening. Example parameters of the site process risks 612 include average days between patient's monitoring visits and number of patients in assigned sites. A person having ordinary skill in the art will appreciate examples of parameters is not limited only to those listed in the FIG. 6.

The risk analyser 104 applies the regression coefficients 502 on the second data 600 to predict potential issues that can be expected between most recent monitoring visits of sites to a current date. The risk analyser 104 computes a protocol compliance score, a site performance score, and a site process score for each site by applying the regression coefficients 502 on the second data. The risk analyser 104 also predicts number of issues on each site by performing regression analysis.

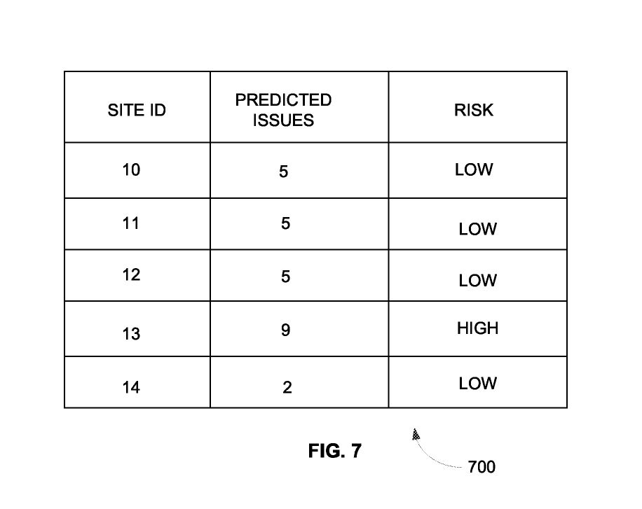

With reference to FIG. 6, FIG. 7 is a table view 700 illustrating a risk level associated with sites according to an embodiment herein. For example, when a number of issues predicted for a site ‘10’ are 5, the risk analyser 104 categorizes the site ‘10’ as a low risk site. In another example, when a number of issues predicted for a site ‘13’ are 9, the risk analyser 104 categorizes the site ‘13’ as a highly risk site. In this example, the risk analyser 104 alerts a user for an immediate action to mitigate risks associated the site ‘13’.

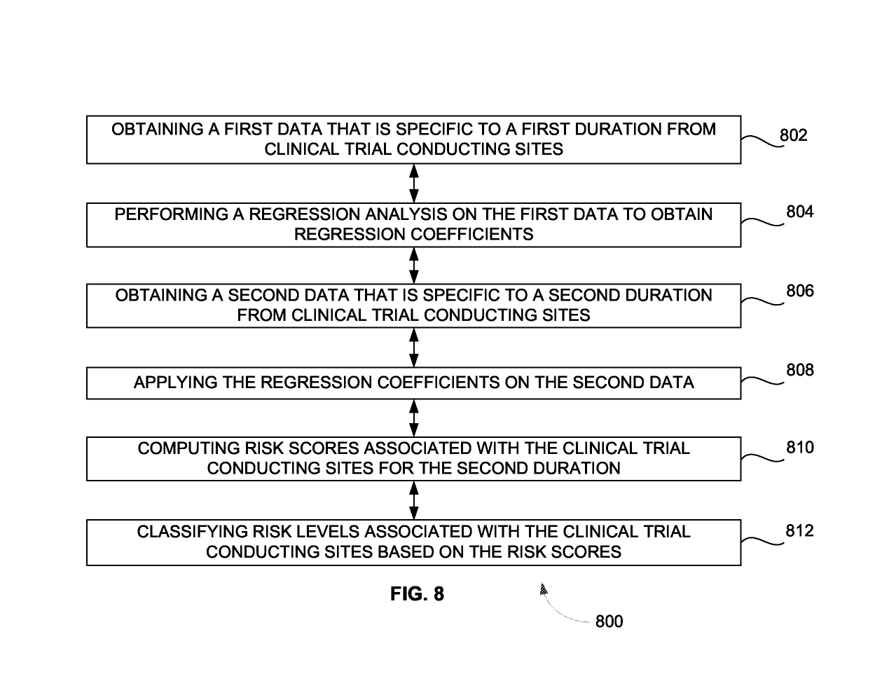

FIG. 8 is a flow diagram 800 illustrating a method for evaluating risks associated with a plurality of sites according to an embodiment herein. In step 802, a first data that is specific to a first duration is obtained from clinical trial conducting sites. The first duration is from start of clinical trials until most recent interventions with sites. In step 804, a regression analysis is performed on the first data to obtain regression coefficients. In step 806, a second data that is specific to a second duration is obtained from the clinical trial conducting sites. The second duration is from the most recent intervention of sites including, but not limited to, from operational, medical, and study management, remote monitoring visit, telephonic follow-up, on-site visits, and tele-presence to a current date. In step 808, the regression coefficients are applied on the second data. In step 810, risks scores associated with the clinical trial conducting sites are computed for the second duration. In step 812, risks levels associated with the clinical trial conducting sites are classified based on the risk scores. The system 100 and methods of various embodiments discussed above can also be implemented using statistical models under generalized linear model (GLM) and other statistical models (i.e., apart from a regression model) which are responsive or dynamic in nature to evaluate risks of sites. In one embodiment, the statistical models selected from (a) Linear Regression, (b) Logistic Regression, (c) Polynomial Regression, (d) Stepwise Regression, (e) Ridge Regression, (f) Lasso Regression, and (g) ElasticNet Regression to evaluate said overall risks associated with said clinical trial conducting sites.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

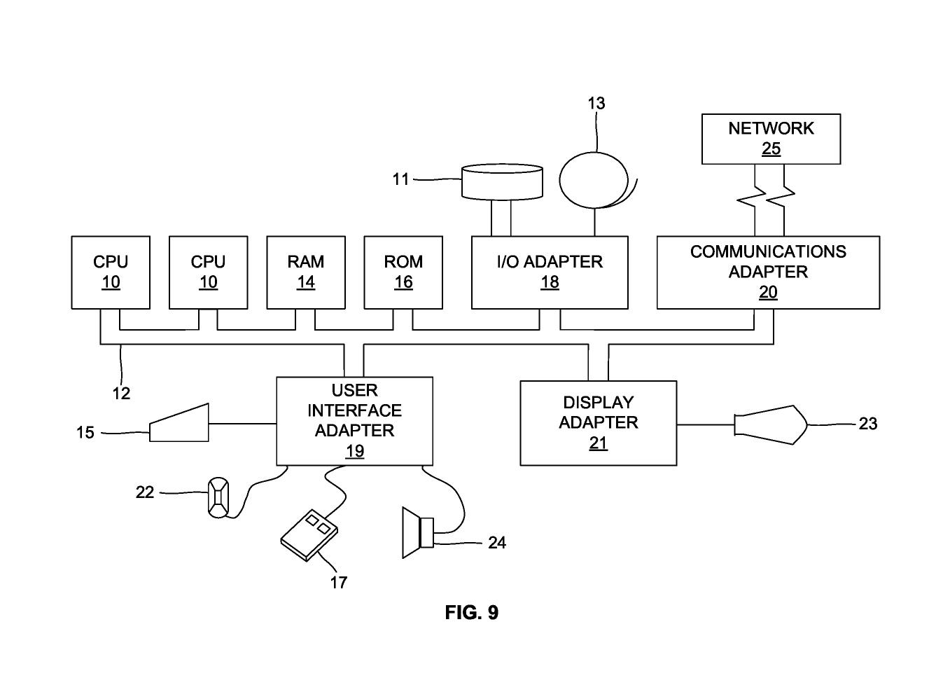

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for evaluating risks of clinical trial conducting sites, comprising:
(a) a memory that stores (i) a set of modules, and (ii) a database, wherein said database stores a risk level associated with each of said clinical trial conducting sites; and
(b) a processor that executes said set of modules, wherein said set of modules comprises:
a first duration data obtaining module, implemented by said processor, that obtains a first data corresponding to a first duration, wherein said first data comprises parameters associated with (i) protocol risks, (ii) site performance risks, and (iii) site process risks of said clinical trial conducting sites;
a regression analysis module, implemented by said processor, that performs a regression analysis on said first data to obtain a number of monitoring visit findings at a clinical trial conducting site in accordance with an equation
(Y)=B1X1+B2X2+ . . . BnXn+ error,
where X1, X2, . . . Xn are parameters and Y is said number of monitoring visit findings at said clinical trial conducting site;
a regression coefficients computing module, implemented by said processor, that applies said equation on said first data to obtain regression coefficients;
a second duration data obtaining module, implemented by said processor, that obtains a second data corresponding to a second duration, wherein said second data comprises parameters associated with (i) said protocol risks, (ii) said site performance risks, and (iii) said site process risks of said clinical trial conducting sites;
a regression coefficients applying module, implemented by said processor, that applies said regression coefficients on said second data to predict potential risks associated with said clinical trial conducting sites;
an overall site risks computing module, implemented by said processor, that computes an overall risks associated with said clinical trial conducting sites; and
a site risk classifying module, implemented by said processor, that classifies a risk level as high, medium, or low that associated with said clinical trial conducting site based on said overall risk associated with said clinical trial conducting site.

2. The system of claim 1, wherein said overall site risks computing module comprises:
a protocol compliance risk score computing module, implemented by said processor, that computes a protocol compliance score for each clinical trial conducting sites by applying said regression coefficients on said second data;
a site performance risk score computing module, implemented by said processor, that computes a site performance score for said each clinical trial conducting sites by applying said regression coefficients on said second data; and
a site process risk score computing module, implemented by said processor, that computes a site process compliance score for said each clinical trial conducting sites by applying said regression coefficients on said second data;

3. The system of claim 1, wherein said system is implemented using at least one (i) statistical models under generalized linear model (GLM), or (ii) a statistical models selected from (a) Linear Regression, (b) Logistic Regression, (c) Polynomial Regression, (d) Stepwise Regression, (e) Ridge Regression, (f) Lasso Regression, and (g) ElasticNet Regression to evaluate said overall risks associated with said clinical trial conducting sites.

4. The system of claim 2, wherein said overall risks associated with said clinical trial conducting sites is computed based on (i) said corresponding protocol compliance risk scores, (ii) said corresponding site performance scores, and (ii) said corresponding site process compliance scores.

5. The system of claim 1, wherein said first duration associated with said first data is calculated from a start of clinical trials until most recent interventions with said clinical trial conducting sites.

6. The system of claim 1, wherein said second duration associated with said first data is calculated from recent interventions of said clinical trial conducting sites, wherein said second duration is calculated from (i) operational, medical, and study management, (ii) remote monitoring visit, (iii) telephonic follow-up, (iv) on-site visits, or (v) tele-presence till a current date.

7. The system of claim 1, wherein said regression analysis module calculates a number of monitoring issues per said clinical trial conducting site by a mathematical form of a regression model
Y=B₁X₁+B₂X₂+ . . . BₙXₙ[PR]+B₁X₁+B₂X₂+ . . . [Sp]+B₁X₁+B₂X₂+ . . . BₙXₙ[Spe],
where PR is related to a protocol risk, Sp is related to a site process, and Spe is related to a site performance. X1 X2 . . . Xn are independent variables.

8. The system of claim 1, wherein said at least one parameter is selected by a clinical trial administrator to monitor said clinical trial conducting site.

9. The system of claim 1, wherein said system allows to add one or more new risk categories and associated parameters to compute said overall risks associated with said clinical trial conducting sites.

10. A computer implemented method for evaluating risks of clinical trial conducting sites, comprising:
obtaining a first data that corresponds to a first duration from said clinical trial conducting sites, wherein said first data comprises parameters associated with (i) protocol risks, (ii) site performance risks, and (iii) site process risks of said clinical trial conducting sites;
performing a regression analysis on said first data to obtain a number of monitoring visit findings at a clinical trial conducting site in accordance with an equation
(Y)=B1X1+B2X2+ . . . BnXn+ error,
where X1, X2, . . . Xn are parameters and Y is said number of monitoring visit findings at said clinical trial conducting site;
obtaining regression coefficients by applying said equation on said first data;
obtaining a second data that corresponds to a second duration from said clinical trial conducting sites, wherein said second data comprises parameters associated with (i) said protocol risks, (ii) said site performance risks, and (iii) said site process risks of said clinical trial conducting sites;
applying said regression coefficients on said second data to predict potential risks associated with said clinical trial conducting sites;
computing an overall risks associated with said clinical trial conducting sites; and
classifying a risk level associated with said clinical trial conducting site based on said overall risk associated with said clinical trial conducting site.

11. The computer implemented method of claim 10, further comprising step of:
recommending said clinical trial conducting site visit when said risk level associated with said clinical trial conducting site is higher than a predefined threshold value.

12. The computer implemented method of claim 10, further comprising step to compute said overall risks associated with said clinical trial conducting sites using said overall site risks computing module that performing steps of:
computing a protocol compliance score for each clinical trial conducting sites by applying said regression coefficients on said second data;
computing a site performance score for said each clinical trial conducting sites by applying said regression coefficients on said second data; and
computing a site process compliance score for said each clinical trial conducting sites by applying said regression coefficients on said second data.

13. The computer implemented method of claim 12, wherein said overall risks associated with said clinical trial conducting sites is computed based on (i) said corresponding protocol compliance risk scores, (ii) said corresponding site performance scores, and (ii) said corresponding site process compliance scores.

14. The computer implemented method of claim 10, wherein said first duration associated with said first data is calculated from a start of clinical trials until most recent interventions with said clinical trial conducting sites.

15. The computer implemented method of claim 10, wherein said second duration associated with said first data is calculated from recent interventions of said clinical trial conducting sites, wherein said second duration is calculated from (i) operational, medical, and study management, (ii) remote monitoring visit, (iii) telephonic follow-up, (iv) on-site visits, or (v) tele-presence till a current date.

16. The computer implemented method of claim 10, further comprising step of:
calculating a number of monitoring issues per said clinical trial conducting site by a mathematical form of a regression model
Y=B₁X₁+B₂X₂+ . . . BₙXₙ[PR]+B₁X₁+B₂X₂+ . . . BₙXₙ[Sp]+B₁X₁+B₂X₂+ . . . BₙXₙ[Spe],
where PR is related to a protocol risk, Sp is related to a site process, and Spe is related to a site performance. X1 X2 . . . Xn are independent variables.

17. One or more non-transitory computer readable storage mediums storing one or more sequences of instructions, which when executed by one or more processors, causes evaluating risks of clinical trial conducting sites, by performing the steps of:
obtaining a first data that corresponds to a first duration from said clinical trial conducting sites, wherein said first data comprises parameters associated with (i) protocol risks, (ii) site performance risks, and (iii) site process risks of said clinical trial conducting sites;
performing a regression analysis on said first data to obtain a number of monitoring visit findings at a clinical trial conducting site in accordance with an equation
(Y)=B1X1+B2X2+ . . . BnXn+ error,
where X1, X2, . . . Xn are parameters and Y is said number of monitoring visit findings at said clinical trial conducting site;
obtaining regression coefficients by applying said equation on said first data;
obtaining a second data that corresponds to a second duration from said clinical trial conducting sites, wherein said second data comprises parameters associated with (i) said protocol risks, (ii) said site performance risks, and (iii) said site process risks of said clinical trial conducting sites;
applying said regression coefficients on said second data to predict potential risks associated with said clinical trial conducting sites;
computing a protocol compliance score for each clinical trial conducting sites by applying said regression coefficients on said second data;
computing a site performance score for said each clinical trial conducting sites by applying said regression coefficients on said second data;
computing a site process compliance score for said each clinical trial conducting sites by applying said regression coefficients on said second data, wherein an overall risks associated with said clinical trial conducting sites computed based on (i) said corresponding protocol compliance risk scores, (ii) said corresponding site performance scores, and (ii) said corresponding site process compliance scores; and
classifying a risk level associated with said clinical trial conducting site based on said overall risk associated with said clinical trial conducting site.

18. The one or more non-transitory computer readable storage mediums storing one or more sequences of instructions of claim 17, further comprising step of:
recommending said clinical trial conducting site visit when said risk level associated with said clinical trial conducting site is higher than a predefined threshold value.

19. The one or more non-transitory computer readable storage mediums storing one or more sequences of instructions of claim 17, further comprising step of:
calculating a number of monitoring issues per said clinical trial conducting site by a mathematical form of a regression model
Y=B₁X₁+B₂X₂+ . . . BₙXₙ[PR]+B₁X₁+B₂X₂+ . . . BₙXₙ[Sp]+B₁X₁+B₂X₂+ . . . BₙXₙ[Spe],
where PR is related to a protocol risk, Sp is related to a site process, and Spe is related to a site performance. X1 X2 . . . Xn are independent variables.
